(19) United States
(12) Patent Application Publication
(10) Pub. No.: US 2006/0154849 A1
(43) Pub. Date: Jul. 13, 2006

(54) Method for hydrosolubilisation of a perfume and solution obtained by said method

(76) Inventors: Jean-Claude Epiphani, Porticcio (FR); Christian Sarbach, Versailles (FR); Pascal Delvordre, Massy (FR)

Correspondence Address: Lumen Intellectual Property Services Inc, 2nd Floor, 2345 Yale Street, Palo Alto, CA, 94306, US

(21) Appl. No.: 10/536,027

(22) PCT Filed: Nov. 19, 2003
(86) PCT No.: PCT/FR03/03426

§ 371 Date: Oct. 21, 2005

(30) Foreign Application Priority Data
Nov. 19, 2002 (FR) 02/14436

(51) Int. Cl. A61Q 13/00

(52) U.S. Cl. 512/1

(57) ABSTRACT

This invention concerns a method for preparing an aqueous solution of perfumes or like substances. This method includes mixing in an aqueous medium an active base and saponins or their equivalents. In the resulting solution the perfume is contained in micro-reservoirs which, after being applied to the skin, provide a prolonged olfactory action without modification of the initial scent. This invention is particularly applicable in the perfume industry and in cosmetology.

### FIELD OF THE INVENTION

The present invention relates generally to the field of cosmetology. More particularly, the present invention relates to a method of producing a water-solubilized perfume.

### BACKGROUND

Alcohol-solubilized perfumes have numerous drawbacks, due to the alcohol present in the perfume. For example, they dry and irritate the epidermis, they are modified by sunlight, they stain clothing, and the alcohol odor interferes with the perfuming base.

Methods for preparing water-solubilized perfumes with various chemical surfactants are well established, but these surfactants cause undesired side effects on the skin or allow only small concentrations of perfume to be used.

The use of cyclodextrins to micro-encapsulate cosmetic components and perfumes, such that they can be released when diluted with water, is also well known. However, these perfumes cannot be kept in a water medium before use and, importantly, the numerous perfume components are not released at the same speed, thereby leading to a noticeable change in the original scent.

Saponins derived from vegetable plants have long been used in the preparation of detergents, e.g. for shampoos, or as surfactants for medicines or for beverages.

### SUMMARY OF THE INVENTION

This invention discloses a method that makes it possible to water solubilize perfumes and similar substances by means of saponins. With this method, the active base can be used at a concentration of up to more than 30%, with lower concentrations also possible depending on need. In the resulting solution, the perfume is contained in micro-reservoirs, the walls of which are molecules of saponin. When the solution is applied to the skin the perfume is released gradually from the micro-reservoirs, without any change of the original scent and with a long lasting olfactory effect. The scent can generally be renewed, even several hours after dissipation, simply by applying water to the skin. This invention applies not only to perfumes but also to all similar substances, such as deodorants and insect repellents.

In summary this invention relates to a process for producing a water-solubilized perfume, or a similar product, by means of saponins, the resulting solution of which, when applied to the skin, gradually releases the perfume contained in micro-reservoirs, the walls of which are saponin molecules, without any change of the original scent and with a long lasting olfactory effect. The process includes the steps of extracting an aqueous solution of saponins from a saponin-containing plant, and mixing the saponin solution with a perfuming base, or similar product, and water.

Aside from the perfuming base, or similar substance, the ingredients of this invention are the following:

Water

The water that is normally used is demineralized water, but soft and lightly mineralized water may also be used.

Saponins

Any kind of vegetable saponin can be suitable, provided that it is free of undesired side effects. The selected plants should possess high concentrations of saponins and be inexpensive to obtain. Soapwort root (saponaria officinalis), for example, is a good candidate vegetable plant, because it is free of side effects, is highly concentrated in saponins and is inexpensive to obtain. In addition, synthetic saponins can be employed with similar results to vegetable-based saponins, by duplicating chemically the active components of vegetable-based saponin molecules. These active components are well known from their use in detergents or surfactants: refer to the handbook “Pharmacognosie, by Jean Bruneton, Tec et Doc editors, Paris, 1999”.

### DETAILED DESCRIPTION OF THE INVENTION

A detailed description of the process according to the present invention is described below.

Aqueous Saponin Solution

Saponins are extracted from the selected plant. The extraction efficiency is enhanced if the plant is finely ground. Water is the preferred extraction solvent, although other solvents, such as some alcohols, can be used successfully. How much the plant is ground, as well as extraction parameters (temperature, duration, degree of stirring, number of stages in the process, etc.), determine the saponin concentration in the resulting solution. Precise measurement of this concentration can be made, particularly by spectrophotometric or chromatographic methods.

With soapwort root, for example, one can proceed as follows:
Pour well-ground soapwort root into demineralized water at 60° C., with a ratio of 2 grams of ground wood for 10 milliliters of water.
Slowly stir the solution for 5 minutes.
Centrifuge the resulting solution.

Using this procedure, an aqueous saponin solution is obtained, the saponin concentration of which can be measured precisely by ultraviolet-visible spectrophotometry, by comparison with a reference solution.

Synthetic saponins may be used in place of vegetable saponins, with similar results. In this case, the extraction step is replaced by chemical synthesis. Synthetic products are then used in the solution instead of vegetable saponins.

Mixing

The following elements are poured into a mixer:

the active base

the aqueous saponin solution

the selected water.

Proportions depend on the active base that is used, the desired effect (scent, deodorant, repellent, etc.), the saponin concentration in the aqueous saponin solution, and the quality of the selected water. The active base concentration can be over 30% by volume. When the saponin extraction step is carried out with solvents other than water, particularly with alcohols, the elements poured into the mixer may also contain minute quantities of these solvents. In addition, the perfume active base, as prepared by its manufacturer, typically contains some solvents, which are often alcoholic solvents. Thus, in addition to the above-mentioned elements, the mixer may contain minute quantities of various solvents, particularly alcoholic solvents.

Once all of the components are in the mixer, the mixer is operated in order to produce a mean size of active base micro-droplets that is as small as possible. Each perfume micro-droplet is coated with saponin molecules, natural or synthetic, thereby forming a perfume micro-reservoir. After mixing, the solution is ready for use. The saponin extraction and mixing processes may be conducted simultaneously.

To make, for example a 10 centiliter solution containing 10% honeysuckle oil by volume, one can use the following quantities:
1 centiliter honeysuckle oil perfuming base, obtained commercially
1 centiliter of aqueous saponin solution containing 10% by weight of saponins extracted from soapwort root as described above
8 centiliters of demineralized water.

Mixing is accomplished, for example, with a paddle-wheel homogenizer rotating at 1,500 rpm for 2 minutes.

Using the Solution

Upon applying the solution to the skin, the perfume micro-reservoirs adhere to the epidermis and the perfume is gradually released without any deterioration of the olfactory effect. This olfactory effect is more long lasting than with perfumes that are solubilized in alcohol with the same concentration of perfume base. The scent can generally be restored, even several hours after dissipation, simply by adding water to the skin.

Saponin molecules, natural or synthetic, not only make water-solubilized perfumes possible, but, above all, they allow a gradual diffusion of the scent or other desired effect (deodorant, repellent, etc.) after application. In contrast, the reaction of perfumes solubilized in alcohol is quite different. When alcohol-solubilized perfumes are applied to the skin, some of the perfume components are lost to the atmosphere (azeotropic effect), due to fast evaporation of the alcohol, and the perfume remains in direct contact with the epidermis. Perfume diffusion is thus faster than with a water-solubilized perfume, which is contained in its microreservoirs. In addition, compared to water-solubilized perfumes, alcohol-solubilized perfumes exhibit a greater change of the original scent together with a shorter action. Once vanished, the scent from an alcohol-solubilized perfume can never be restored.

The water perfume solution can also be employed in the preparation of various non-aqueous cosmetic products, such as cosmetic creams, making it possible to reach high active base concentrations.

What is claimed is:

1. A process for producing a water solubilized perfume, or similar substance, by means of saponins, the resulting solution of which, when applied on the skin, gradually releases the perfume contained in micro-reservoirs, the walls of which are saponin molecules, without any change of the original scent and with a long lasting olfactory effect, comprising the steps of:
(a) producing an aqueous solution of saponins from provided saponins; and
(b) mixing said aqueous solution of saponins with a perfuming active base, or similar product, and a water medium.

2. A process according to claim 1, wherein said provided saponins are derived from vegetables.

3. A process according to claim 1, wherein said provided saponins are synthetic.

4. A process according to claim 1, wherein said water medium is demineralized water.

5. A process according to claim 1, wherein said water medium is soft and lightly mineralized water.

6. A process according to claim 1, wherein said water medium contains, in limited quantities, solvents other than water, especially alcoholic solvents.

7. A process according to claim 1, wherein the concentration of said active base is over 30% by volume.

8. A solution obtained by the process as set forth in claim 1.
